(19) United States
(12) Patent Application Publication
(10) Pub. No.: US 2015/0173555 A1
(43) Pub. Date: Jun. 25, 2015

(54) BEVERAGE EXTRACTION VESSEL

(71) Applicant: TECHNO PROSYS CO., LTD., Kanazawa-shi (JP)

(72) Inventors: Takeshi SUMIYOSHI, Yokohama-shi (JP); Yoshihiro YAMATO, Yokohama-shi (JP); Yasuaki TAKASAKI, Yokohama-shi (JP)

(73) Assignee: TECHNO PROSYS CO., LTD., Kanazawa-shi (JP)

(21) Appl. No.: 14/331,530

(22) Filed: Jul. 15, 2014

(30) Foreign Application Priority Data
Dec. 19, 2013 (JP) 2013-263113

(51) Int. Cl. A47J 31/06

(52) U.S. Cl. CPC A47J 31/06

(57) ABSTRACT

A beverage extraction vessel includes: a cylindrical side wall; and a bottom wall that clogs a bottom portion of the side wall. The side wall has a plurality of slits smaller in area with increasing proximity to outside in a thickness direction.

### CROSS-REFERENCE TO RELATED APPLICATION

This application claims priority from Japanese Patent Application No. 2013-263113 filed with the Japan Patent Office on Dec. 19, 2013, the entire content of which is hereby incorporated by reference.

### BACKGROUND

1. Technical Field

The present disclosure relates to a beverage extraction vessel that extracts beverage from beverage material.

2. Related Art

In recent years, automatic cup-of-beverage vending machines have been in widespread use to allow consumers to readily enjoy authentic coffee outdoors. The automatic cup-of-beverage vending machines extract coffee liquid from coffee beans that are ground into powder, and serve and sell the coffee liquid by paper cups. In addition, coffee makers, which extract coffee liquid from powdered coffee beans, have been popular to readily enjoy authentic coffee at home.

Coffee extractors used in such automatic vending machines and coffee makers include, in many cases, a cup-shaped support member and a filter covering the bottom portion of the support member or openings formed at side portion of the support member. This filter is made of woven cloth, paper, plastic fiber, or the like (see, for example, JP-A-2012-530531).

### SUMMARY

A beverage extraction vessel includes: a cylindrical side wall; and a bottom wall that clogs a bottom portion of the side wall. The side wall has a plurality of slits smaller in area with increasing proximity to outside in a thickness direction.

### BRIEF DESCRIPTION OF DRAWINGS

FIG. 1 is a perspective view of a beverage extraction vessel according to a first embodiment of the present disclosure, as seen obliquely from above;

FIG. 2 is a side view of the beverage extraction vessel according to the embodiment;

FIG. 3 is a cross-sectional view of the beverage extraction vessel according to the embodiment, taken along line A-A in FIG. 2;

FIG. 4 is a lateral cross-sectional view of a slit arranged in the beverage extraction vessel according to the embodiment;

FIG. 5 is a diagram illustrating results of experiments at which extraction of coffee liquid was made by the beverage extraction vessel according to the embodiment, beverage extraction vessels with different numbers of slits arranged on a side wall, and a conventional beverage extraction vessel;

FIG. 6 is a side view of a beverage extraction vessel according to a second embodiment;

FIG. 7 is a diagram illustrating a modification example of the beverage extraction vessel according to the second embodiment; and

FIG. 8 is a side view of a beverage extraction vessel according to a third embodiment.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Conventional coffee extractor is formed by combining a plurality of members and thus has a complicated structure. In addition, to manufacture such a coffee extractor, a filter is closely attached to a cup-shaped support member to prevent powder of coffee beans from spilling from a clearance between the support member and the filter. Thus, such a coffee extractor can be hardly produced at low cost. In addition, the filter is low in strength, and thus, in many cases, the filter is discarded after use of one or several times. This leads to cost increase and waste of resources. Further, the filter easily lets liquid through and is difficult to extract rich coffee liquid.

From the viewpoints of cost reduction and effective use of resources, there is demand for a high-durability beverage extractor that has a simple structure and can be manufactured at low cost. There is also demand for a beverage extractor that can extract rich and tasty beverage.

One object of the present disclosure is to provide a beverage extraction vessel having a simple structure.

Another object of the present disclosure is to provide a beverage extraction vessel that can be manufactured at low cost.

Still another object of the present disclosure is to provide a beverage extraction vessel with high durability.

Further another object of the present disclosure is to provide a beverage extraction vessel that can extract rich beverage.

A beverage extraction vessel according to one embodiment of the present disclosure (the beverage extraction vessel) includes a cylindrical side wall and a bottom wall that clogs a bottom portion of the side wall. The side wall has a plurality of slits that is smaller in area with increasing proximity to an outside in a thickness direction.

As the beverage extraction vessel has on the side wall the plurality of slits that are smaller in area with increasing proximity to the outside of the side wall in the thickness direction, beverage material put into the beverage extraction vessel enters into the slits to clog the slits. Accordingly, when hot water is poured into the beverage extraction vessel, a hot water pool is formed in the beverage extraction vessel. In addition, the hot water can evenly spread to the beverage material, allowing extraction of rich beverage. The beverage extraction vessel also has a simple structure in which the plurality of slits is formed on the side wall, and thus can be manufactured at low cost.

In the beverage extraction vessel, the slits may have a lateral cross-section in a trapezoidal shape.

According to this configuration, the lateral cross-section of the slits has a trapezoidal shape. Thus, the beverage material, when being put into the beverage extraction vessel, is prone to enter into the slits to easily clog the slits. Thus, when hot water is poured into the beverage extraction vessel, a hot water pool can be formed in the beverage extraction vessel. Further, the hot water can evenly spread over the beverage material. Thus, rich beverage can be extracted from the beverage material.

In the beverage extraction vessel, the plurality of slits may be above the bottom wall (for example, a position separate from the bottom wall).

According to this configuration, when hot water is poured into the beverage extraction vessel, a hot water pool is formed on a bottom portion of the beverage extraction vessel. Thus, rich beverage can be extracted.

In the beverage extraction vessel, the plurality of slits may vertically extend on the side wall.

According to this configuration, hot water poured into the beverage extraction vessel can discharge beverage to the outside little by little from the vertical position of the slits in the course of spreading to the beverage material in the beverage extraction vessel and going down.

In the beverage extraction vessel, the plurality of slits may be arranged on the side wall in a circumferential direction.

According to this configuration, hot water poured into the beverage extraction vessel can be evenly spread over the beverage material in the beverage extraction vessel, and beverage can be discharged from the respective slits to the outside in an almost uniform manner.

In the beverage extraction vessel, the plurality of slits may be arranged on the side wall in a vertical direction.

According to this configuration, when hot water is poured into the beverage extraction vessel, a hot water pool can be formed between the vertically-arranged slits, allowing extraction of rich beverage.

In the beverage extraction vessel, the plurality of slits may be arranged on the side wall in a matrix.

According to this configuration, hot water can be poured into the beverage extraction vessel to evenly spread to the beverage material in the beverage extraction vessel. Further, a hot water pool can be formed between the vertically-arranged slits. Therefore, rich beverage can be extracted.

The beverage extraction vessel may be formed by plastic resin. According to this configuration, the beverage extraction vessel is partly or entirely formed of plastic resin. The beverage extraction vessel can be easily produced with high durability. Therefore, cost reduction and effective use of resources can be attained.

The beverage extraction vessel has on the side wall the plurality of slits that is smaller in area with increasing proximity to outside of the side wall in a thickness direction. Thus, the beverage material put into the beverage extraction vessel enters into the slits to clog the slits. Hence, when hot water is poured into the beverage extraction vessel, a hot water pool is formed in the beverage extraction vessel. Further, the hot water is allowed to evenly spread over the beverage material. Therefore, rich beverage can be extracted. In addition, the beverage extraction vessel has a simple structure in which the plurality of slits is arranged on the side wall, and thus can be manufactured at low cost.

Embodiments for carrying out the present disclosure will be described below in detail with reference to the drawings.

### First Embodiment

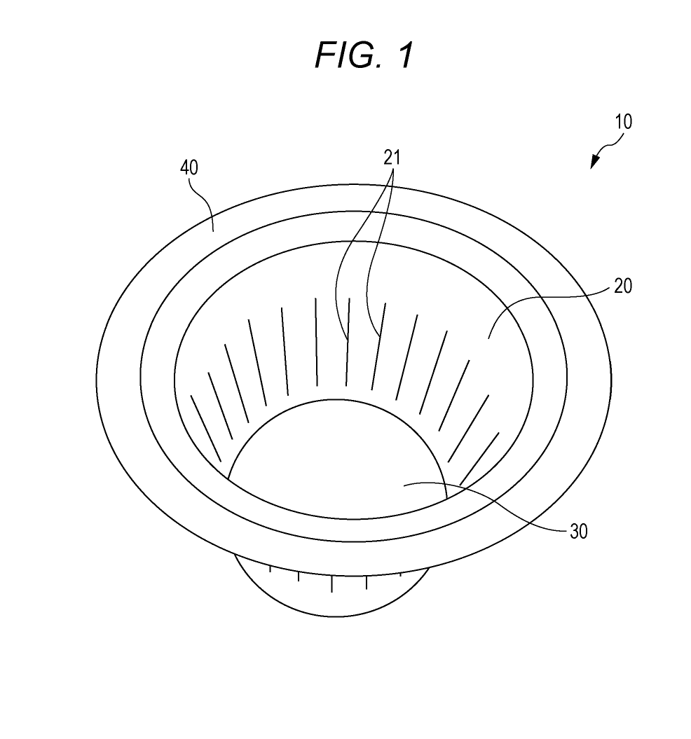

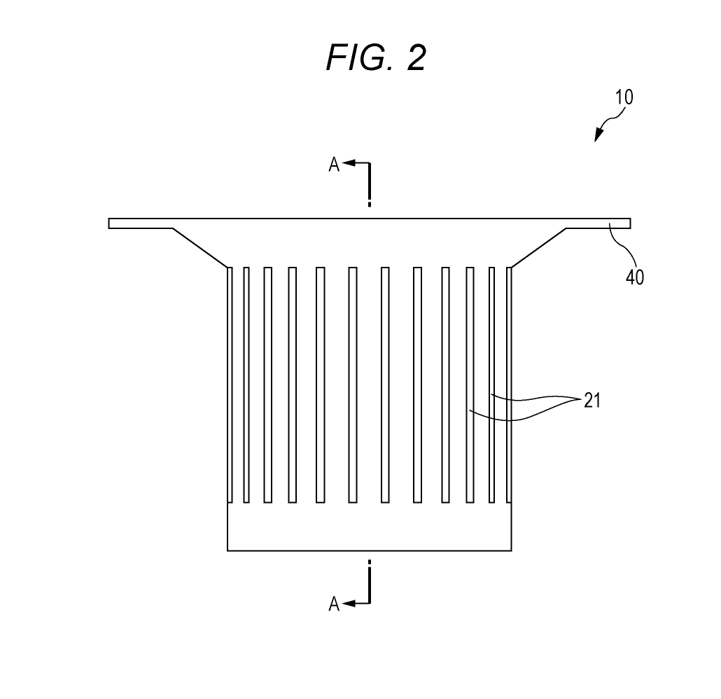

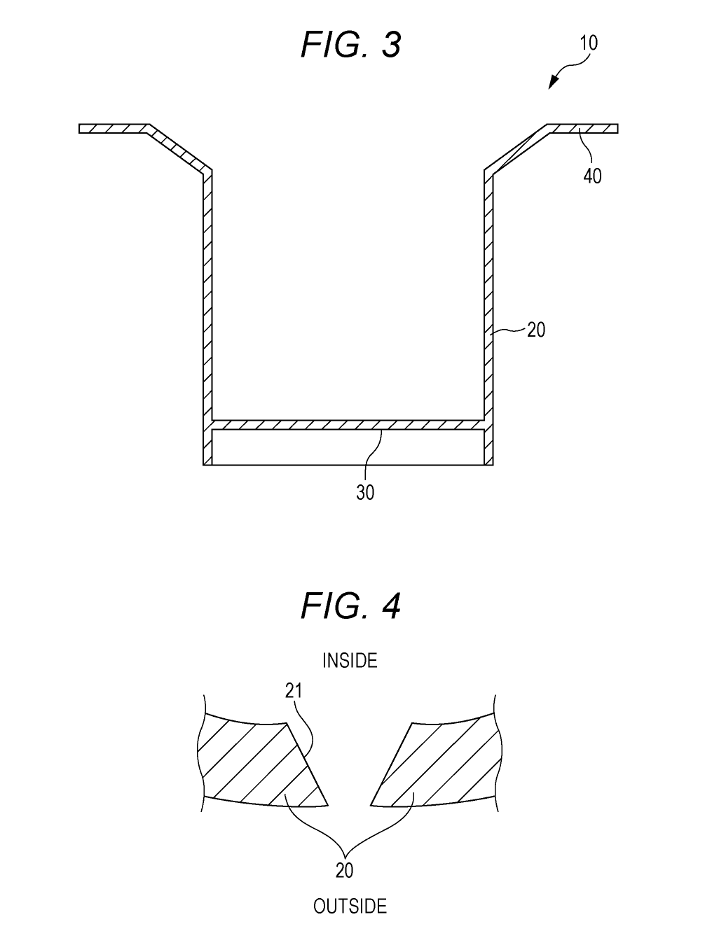

FIG. 1 is a perspective view of a beverage extraction vessel 10 according to a first embodiment of the present disclosure, as seen obliquely from above. FIG. 2 is a side view of the beverage extraction vessel 10. FIG. 3 is a cross-sectional view of the beverage extraction vessel 10 taken along line A-A in FIG. 2. As illustrated in these drawings, the beverage extraction vessel 10 includes a cylindrical side wall 20 and a bottom wall 30 that clogs a bottom portion of the side wall 20. The side wall 20 has a flange 40 at an upper end thereof.

The beverage extraction vessel 10 has an open upper portion. Material for beverage such as coffee beans ground into powder, for example, is put from top into an inside of the beverage extraction vessel 10. Then, when hot water is poured from top into the inside, the hot water and the beverage material are mixed together and beverage is extracted from the beverage material. The beverage material may be coffee beans ground into powder. Alternatively, the beverage material may be, for example, tea leaves for green tea, oolong tea, or black tea. Alternatively, furthermore, the beverage material may be, for example, buckwheat fruit for buckwheat tea or black beans for black beans tea.

The side wall 20 is provided with a plurality of slits 21 to discharge beverage extracted in the beverage extraction vessel 10 to the outside. In the embodiment, the slits 21 vertically extend on the side wall 20. In the embodiment, the 24 slits 21 are arranged on the side wall 20 at almost equal intervals in the circumferential direction. Each of the slits 21 has an elongated rectangular shape when seen from the outside and inside of the side wall 20.

The number of the slits 21 is not limited to 24 but may be any number larger than one. However, taking into account a residence time of hot water in the beverage extraction vessel 10 and the like, the number of the slits 21 is preferably 12 or more.

The slits 21 are positioned above the bottom wall 30. Thus, the slits 21 do not extend to the position of the bottom wall 30. That is, the slits 21 are provided at a position above the bottom wall 30. Thus, when hot water is poured into the beverage extraction vessel 10, a hot water pool can be formed at the bottom portion of the beverage extraction vessel 10, allowing the beverage extraction vessel 10 to extract rich beverage.

FIG. 4 is a lateral cross-sectional view of one slit 21 of the plurality of slits 21 arranged on the side wall 20. As illustrated in FIG. 4, the lateral cross-sectional view of the slit 21 is trapezoidal. The shorter upper bottom of the trapezoid is positioned outside the side wall 20. The longer lower bottom of the trapezoid is positioned inside the side wall 20. Specifically, the slit 21 is shaped to be smaller in cross-sectional area in a direction perpendicular to the thickness direction with increasing proximity to outside of the side wall 20 in the thickness direction. In this case, the slit 21 actually has the shape of a frustum of pyramid.

For example, when the diameter of the beverage material is about 0.12 to 0.14 mm, the length of the lower bottom of the trapezoid in the slit 21 may be set to about 0.15 mm larger than the diameter of the beverage material, and the length of the upper bottom of the same may be set to about 0.1 mm smaller than the diameter of the beverage material. By setting the slits 21 in such a size as described above, the beverage material put into the beverage extraction vessel 10 enters into the slits 21. However, the beverage material can be prevented from being discharged in large volume from the slits 21 to the outside.

As described above, the beverage extraction vessel 10 is provided with the plurality of slits 21 that is smaller in area with increasing proximity to outside of the side wall 20 in the thickness direction. Thus, the beverage material put into the beverage extraction vessel 10 enters into the slits 21 to clog the slits 21. In this state, when hot water is poured into the beverage extraction vessel 10, a hot water pool is formed in the beverage extraction vessel 10. Further, the hot water can be evenly spread over the beverage material. Therefore, the beverage extraction vessel 10 can extract rich beverage. The beverage extraction vessel 10 also has a simple structure with the plurality of slits 21, and thus can be manufactured at low cost.

The lateral cross-sectional shape of the slits 21 is not limited to a trapezoidal shape. The lateral cross-sectional shape of the slits 21 only needs to be smaller in area with increasing proximity to outside of the side wall 20 in the thickness direction, such that the beverage material put into the beverage extraction vessel 10 is prone to enter into the slits 21, and is less prone to be discharged from the slits 21 to the outside.

The beverage extraction vessel 10 is entirely formed of plastic resin. Thus, the beverage extraction vessel 10 has high durability and can be used repeatedly. To manufacture the beverage extraction vessel 10, there is no need for a step of joining together a plurality of members. The beverage extraction vessel 10 can be easily manufactured using a mold or the like. This realizes cost reduction and effective use of resources. The material for the beverage extraction vessel 10 is not limited to plastic resin but may be metal or cardboard. The beverage extraction vessel 10 may be partly or entirely formed of plastic resin.

In this embodiment, each of the slits 21 has an elongated rectangular shape as seen from the outside and inside of the beverage extraction vessel 10. The shape of the slit 21 seen from outside and inside of the beverage extraction vessel 10 is not limited to this but may be an arbitrary shape such as a curve, a rhomboid, an oval, or a tapered shape. Alternatively, the slits 21 may extend in the lateral direction, not in the vertical direction. The slits 21 may extend in an oblique direction.

The slits may be arranged mainly at the lower portion of the side wall 20, not at the upper portion of the same. A hot water pool is therefore formed at the upper side of the beverage extraction vessel 10, allowing the beverage extraction vessel 10 to extract rich beverage.

In the embodiment, the side wall 20 is cylindrical. The shape of the side wall 20 is not limited to this but may be of a frustum of cone larger in diameter at the upper side, a frustum of cone larger in diameter at the low side, a square column, or frustum of pyramid.

To use the beverage extraction vessel 10, the beverage extraction vessel 10 is set in a predetermined position of a beverage extraction device such as an automatic vending machine, a coffee maker, or the like. Then, beverage material is put into the beverage extraction vessel 10 from above the beverage extraction vessel 10. Then, hot water is poured into the beverage extraction vessel 10. The speed of pouring the hot water is adjusted based on the size of the beverage extraction vessel 10, the size of the slits 21, and the size of the cup into which beverage is supplied. The hot water poured into the beverage extraction vessel 10 spreads from an upper center of the beverage extraction vessel 10 in the outward and downward directions. Then, the hot water mixes with the beverage material while forming a hot water pool. Accordingly, beverage is extracted from the beverage material. The extracted beverage is discharged to the outside in almost uniform manner from the respective slits 21 arranged on the side wall 20 at equal intervals, in the course of spreading outwardly and going downward. The discharged beverage is supplied into a cup placed below the beverage extraction vessel 10.

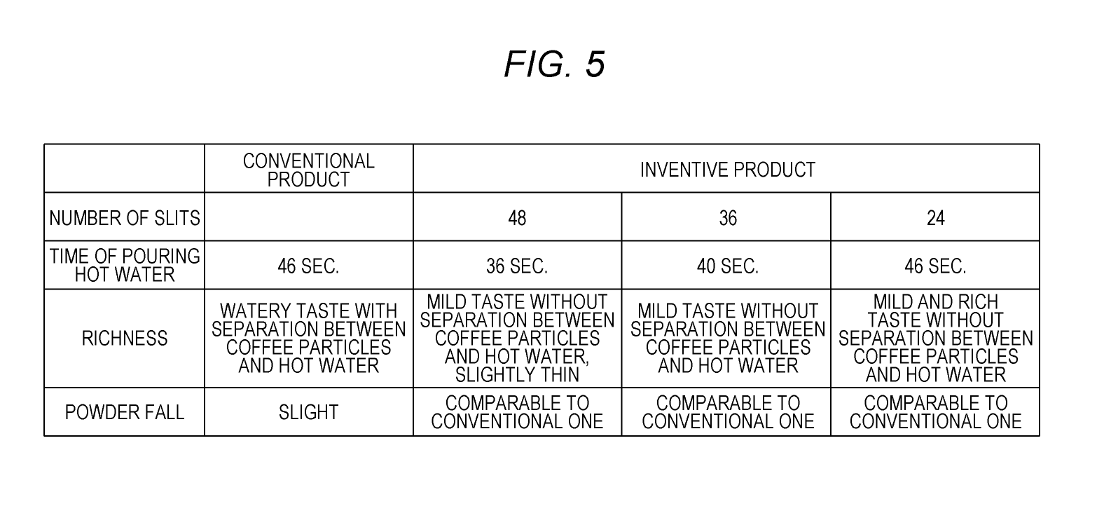

Coffee beans ground into powder were put into a conventional beverage extraction vessel having a support member and a filter attached to the support member and beverage extraction vessels according to the embodiment (including the beverage extraction vessel 10), and then hot water was poured into the vessels to extract coffee liquid. Then, the foregoing vessels were evaluated for time of pouring hot water, richness of coffee liquid, and powder fall. The used beverage extraction vessels according to the embodiment are the beverage extraction vessel 10 having the 24 slits 21, a beverage extraction vessel having 36 slits 21, and a beverage extraction vessel having 48 slits 21. The conventional beverage extraction vessel and the beverage extraction vessels according to the embodiment were nearly equal in capacity. The capacity is smaller than that of the cup into which the coffee liquid is supplied. FIG. 5 provides results of the evaluation. The coffee liquid extracted using the conventional beverage extraction vessel was less rich in taste because the coffee component and the hot water were separated. Meanwhile, when the beverage extraction vessel 10 having the 24 slits 21 was used, the time of pouring hot water was longer than that in the case of using the beverage extraction vessel having the 36 or 48 slits 21 according to the embodiment. However, mild and rich coffee liquid could be obtained without separation between the coffee component and the hot water. As indicated in FIG. 5, the larger the number of the slits 21, the time of pouring hot water became shorter and the coffee liquid became thinner.

### Second Embodiment

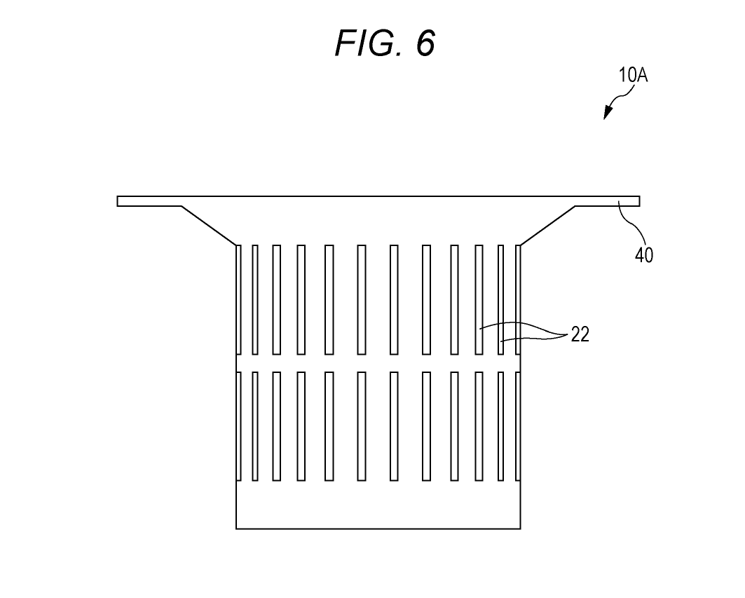

Next, a second embodiment of the present disclosure will be descried. FIG. 6 is a side view of a beverage extraction vessel 10A according to the second embodiment. Descriptions will be given as to a difference between the beverage extraction vessel 10 according to the first embodiment and the beverage extraction vessel 10A according to the second embodiment. In the first embodiment, one slit 21 each is arranged on the side wall 20 in the vertical direction. Meanwhile, in the second embodiment, a plurality of slits 22 is arranged on the side wall 20 in the vertical direction. In the beverage extraction vessel 10A illustrated in FIG. 6, two slits 22 each are arranged in the vertical direction. The number of the slits 22 arranged in the vertical direction is not limited to two but may be three or more. Other configurations of the beverage extraction vessel 10A according to the second embodiment are virtually the same as those of the beverage extraction vessel 10 according to the first embodiment.

As described above, the beverage extraction vessel 10A has the plurality of slits 22 arranged in the vertical direction. Thus, when hot water is poured into the beverage extraction vessel 10A, a hot water pool can be formed between the vertically-arranged slits 22, allowing the beverage extraction vessel 10A to extract rich beverage.

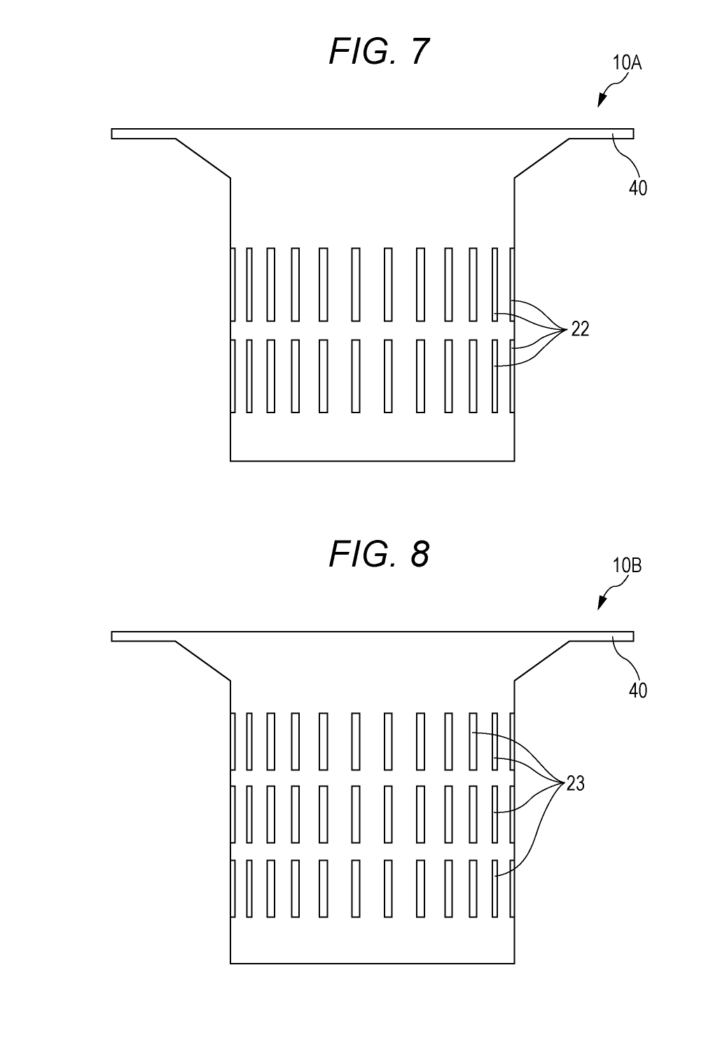

In addition, as illustrated in FIG. 7, the slits 22 may be arranged mainly at the lower portion of the side wall 20, not at the upper portion of the same. Thus, a hot water pool is also formed at the upper portion of the side wall 20, allowing the beverage extraction vessel 10A to extract further rich beverage.

### Third Embodiment

Next, a third embodiment of the present disclosure will be described. FIG. 8 is a side view of a beverage extraction vessel 10B according to the third embodiment. In the beverage extraction vessel 10B according to the third embodiment, as illustrated in FIG. 8, a plurality of slits 23 is arranged in a matrix on the side wall 20. Other configurations of the beverage extraction vessel 10B according to the third embodiment are virtually the same as those of the beverage extraction vessel 10 according to the first embodiment.

As described above, the beverage extraction vessel 10B has the slits 23 arranged in a matrix. Accordingly, it is possible to allow hot water poured into the beverage extraction vessel 10B to evenly spread to the beverage material in the beverage extraction vessel 10B. Further, a hot water pool can be formed between the vertically-arranged slits 23, allowing the beverage extraction vessel 10B to produce rich beverage.

The beverage extraction vessel according to the present disclosure may be any one of the following first to eighth beverage extraction vessels:

The first beverage extraction vessel is a beverage extraction vessel for extracting beverage from beverage material, including a cylindrical side wall and a bottom wall that clogs a bottom portion of the side wall, the side wall being provided with a plurality of slits smaller in area with increasing proximity to outside in a thickness direction.

The second beverage extraction vessel is the first beverage extraction vessel in which the respective slits have a trapezoidal shape in lateral cross-section.

The third beverage extraction vessel is the first or second beverage extraction vessel in which the slits are positioned above the bottom wall.

The fourth beverage extraction vessel is any one of the first to third beverage extraction vessels in which the respective slits vertically extend on the side wall.

The fifth beverage extraction vessel is any one of the first to fourth beverage extraction vessels in which the plurality of slits is arranged on the side wall in the circumferential direction.

The sixth beverage extraction vessel is any one of the first, second, third, and fifth beverage extraction vessels in which the plurality of slits is arranged on the side wall in the vertical direction.

The seventh beverage extraction vessel is any one of the first, second, third, fifth, and sixth beverage extraction vessels in which the plurality of slits is arranged on the side wall in a matrix.

The eighth beverage extraction vessel is any one of the first to seventh beverage extraction vessels in which the beverage extraction vessel is entirely formed of plastic resin.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A beverage extraction vessel, comprising:
a cylindrical side wall; and
a bottom wall that clogs a bottom portion of the side wall, wherein
the side wall has a plurality of slits smaller in area with increasing proximity to outside in a thickness direction.

2. The beverage extraction vessel according to claim 1, wherein the slit has a trapezoidal shape in lateral cross-section.

3. The beverage extraction vessel according to claim 1, wherein the slit has an inner width larger than a diameter of beverage material and an outer width smaller than the diameter of the beverage material.

4. The beverage extraction vessel according to claim 1, wherein the plurality of slits is positioned above the bottom wall.

5. The beverage extraction vessel according to claim 1, wherein the plurality of slits vertically extends on the side wall.

6. The beverage extraction vessel according to claim 1, wherein the plurality of slits is arranged on the side wall in a circumferential direction.

7. The beverage extraction vessel according to claim 1, wherein the plurality of slits is arranged on the side wall in a vertical direction.

8. The beverage extraction vessel according to claim 1, wherein the plurality of slits is arranged on the side wall in a matrix.

9. The beverage extraction vessel according to claim 1, wherein the number of the slits is 12 or more.

10. The beverage extraction vessel according to claim 1, wherein the beverage extraction vessel is formed of plastic resin.
